(19) United States
(12) Patent Application Publication
(10) Pub. No.: US 2020/0372488 A1
(43) Pub. Date: Nov. 26, 2020

(54) System, Method, and Computer Program Product for a Controlled Delivery System

(71) Applicant: Visa International Service Association, San Francisco, CA (US)

(72) Inventor: Gurpreet Singh Bhasin, Fremont, CA (US)

(21) Appl. No.: 16/417,770

(22) Filed: May 21, 2019

(51) Int. Cl. G06Q 20/32; G06Q 20/40; H04W 4/80

(52) U.S. Cl. CPC G06Q 20/3224; H04W 4/80; G06Q 20/4014; G06Q 20/3278

(57) ABSTRACT

Disclosed is a system for releasing an item from a controlled delivery system that includes at least one processor programmed or configured to receive an order message, wherein the order message comprises purchase item data associated with an item that is involved in an order, determine that a payment transaction for the order is processed, transmit the purchase item data to a controlled delivery system at a merchant location based on determining that the payment transaction for the order is processed, determine that a user device is in proximity to the location of the merchant location, and transmit a control signal to cause the controlled delivery system to release the item based on determining that the user device is in proximity to the location of the merchant location. A computer-implemented method and computer program product are also disclosed.

### BACKGROUND

### 1. Field

This disclosed subject matter relates generally to methods, systems, and products for a controlled delivery system and, in some particular embodiments or aspects, to a method, system, and computer program product for providing an item from a controlled delivery system.

### 2. Technical Considerations

Individuals may place orders when purchasing goods and/or services prior to picking up these goods and/or services. For example, an individual may call ahead to have a prescription prepared at a pharmacy. To retrieve the prescription, once filled, the individual often goes to the pharmacy to pick up the prescription, and provides identification and payment. This process can be inefficient, with an individual being required to communicate with the pharmacy such that the individual may arrive at the pharmacy within the pharmacy's normal business hours, provide identification for the individual and, in some cases, provide a physical copy of a written prescription to a pharmacist before the prescription is released. Similar inefficiencies may be found in other contexts where orders may be made based on communication from an individual. For example, an individual may place orders in advance for coffee, groceries, and/or the like, that, once placed, may also include the individual retrieving the order in person, during business hours, to complete the order.

This process is inefficient in that the individual needs to be able to arrive at the merchant prior to the close of business for the day and interact with another individual in order to obtain goods associated with an order placed by the individual. Furthermore, the individual may be required to transmit and receive a number of messages that are unnecessary. In addition, the condition of the subject of the order, for example, medicine associated with a prescription, a food or drink item, groceries, and/or the like, may deteriorate if the subject of the order is not received within a predetermined time period.

### SUMMARY

Accordingly, disclosed are systems, methods, and computer-program products for providing a controlled delivery system are disclosed that overcome some or all of the deficiencies of the prior art.

According to a non-limiting embodiment, provided is a system for providing an item from a controlled delivery system, the system comprising: at least one processor programmed or configured to: receive an order message, wherein the order message comprises purchase item data associated with an item that is involved in an order; determine that a payment transaction for the order is processed; transmit the purchase item data to a controlled delivery system at a merchant location based on determining that the payment transaction associated with the order is processed; determine that a user device is in proximity to the location of the merchant location; and cause the controlled delivery system to release the item based on determining that the user device is in proximity to the location of the merchant location.

Wherein, when receiving the order message, the at least one processor is programmed or configured to: receive the order message from the user device of a consumer involved in the payment transaction.

Wherein, when receiving the order message, the at least one processor is programmed or configured to: receive the order message from the user device prior to determining that the user device is in proximity to the location of the merchant location.

Wherein the at least one processor is further programmed or configured to: transmit a control signal for operating the controlled delivery system to the user device; and cause the user device to transmit the control signal to the controlled delivery system via a short-range wireless communication connection to cause the controlled delivery system to release the item.

Wherein, when causing the controlled delivery system to release the item, the at least one processor is programmed or configured to: transmit a control signal to the controlled delivery system to cause the controlled delivery system to release the item.

Wherein the user device comprises a head unit of a vehicle.

Wherein, when determining that the user device is in proximity to the location of the merchant location, the at least one processor is further programmed or configured to: receive user identification data associated with a user identifier from the user device; receive, from the controlled delivery system, user verification data associated with verification of a user device, the user verification data comprising a user identifier transmitted to the controlled delivery system via a short-range wireless communication connection; compare the user identifier received from the user device and the user identifier received by the controlled delivery system; and determine that the user device is in proximity to the location of the merchant location based on comparing the user identifier received from the user device and the user identifier received by the controlled delivery system.

According to a non-limiting embodiment, provided is a computer-implemented method for providing an item from a controlled delivery system, the computer-implemented method comprising: receiving, with at least one processor, an order message from a user device; determining, with at least one processor, that a payment transaction associated with the order is processed; transmitting, with at least one processor, purchase item data to a controlled delivery system at a merchant location based on determining that the payment transaction associated with the order is processed; determining, with at least one processor, whether the user device is in proximity to a location of the merchant location; and causing, with at least one processor, the controlled delivery system to release the item based on determining that the user device is in proximity to the location of the merchant location.

The computer-implemented method further comprising: receiving the order message from the user device; and determining a location of the user device based on location data associated with the location of the user device; and wherein determining, with at least one processor, that the user device is in proximity to the location of the merchant location comprises: determining, with at least one processor, that the user device is in proximity to the location of the merchant location based on the location of the user device.

The computer-implemented method, wherein receiving, with at least one processor, the order message comprises: receiving, with at least one processor, the order message from the user device when the user device is not in proximity to the location of the merchant location.

The computer-implemented method, further comprising: transmitting, with at least one processor, a control signal to the user device, wherein the control signal causes the controlled delivery system to operate; and causing, with at least one processor, the controlled delivery system to release the item based on receiving the control signal via a short range wireless communication connection.

The computer-implemented method, wherein determining, with at least one processor, whether the user device is in proximity to the location of the merchant location comprises: receiving location data associated with a location of the user device; comparing the location of the user device to the location of the merchant location; and determining that the user device is in proximity to the location of the merchant location based on the location of the user device.

The computer-implemented method, further comprising: authenticating, with at least one processor, the user device for access to the controlled delivery system based on determining that the user device is in proximity to the location of the merchant location.

The computer-implemented method, wherein authenticating, with at least one processor, the user device for access to the controlled delivery system comprises: transmitting, with at least one processor, authentication request data associated with an authentication request to the user device; receiving, with at least one processor, authentication response data associated with an authentication response from the user device; and determining, with at least one processor, that the authentication response is valid.

According to a non-limiting embodiment, provided is a computer program product for providing an item from a controlled delivery system, the computer program product comprising at least one non-transitory computer-readable medium comprising one or more instructions that, when executed by at least one processor, cause the at least one processor to: receive an order message, wherein the order message includes purchase item data associated with an item that is involved in an order; determine that a payment transaction for the order is processed; transmit the purchase item data to a controlled delivery system at a location of a merchant location based on determining that the payment transaction associated with the order is processed; determine that a user device is in proximity to the merchant location; and cause the controlled delivery system to release the item based on determining the user device is in proximity to the merchant location.

The computer program product, wherein the one or more instructions that cause the at least one processor to receive the order message cause the at least one processor to: receive the order message from the user device.

The computer program product, wherein the one or more instructions further cause the at least one processor to: process the payment transaction based on receiving the order message.

The computer program product, wherein the one or more instructions further cause the at least one processor to: transmit, to the user device, a control signal to the user device, wherein the control signal causes the controlled delivery system to operate; cause the controlled delivery system to release the item based on receiving the control signal via a short-range wireless communication connection from the user device.

The computer program product, wherein the merchant location comprises the controlled delivery system, and wherein the one or more instructions that cause the at least one processor to determine that the user device is in proximity to the merchant location cause the at least one processor to: determine that the user device is in proximity to the controlled delivery system; and wherein the one or more instructions that cause the at least one processor to determine that the user device is in proximity to the controlled delivery system cause the at least one processor to: receive location data associated with a location of the user device from the user device; compare the location of the user device to a location of the controlled delivery system; and determine the user device is in proximity to the controlled delivery system.

The computer program product, wherein the one or more instructions further cause the at least one processor to: authenticate an identity of the user device for access to the controlled delivery system, wherein the one or more instructions that cause the at least one processor to authenticate the identity of the user device cause the at least one processor to: transmit authentication request data associated with an authentication request to the user device; receive authentication response data associated with an authentication response from the user device, wherein the authentication response data comprises identification data associated with the identity of the user device; and determine that the identifier of the user device is valid based on the identity of the user device.

Further non-limiting embodiments or aspects are set forth in the following numbered clauses:

Clause 1: A system for providing an item from a controlled delivery system, the system comprising: at least one processor programmed or configured to: receive an order message, wherein the order message comprises purchase item data associated with an item that is involved in an order; determine that a payment transaction for the order is processed; transmit the purchase item data to a controlled delivery system at a merchant location based on determining that the payment transaction associated with the order is processed; determine that a user device is in proximity to the location of the merchant location; and cause the controlled delivery system to release the item based on determining that the user device is in proximity to the location of the merchant location.

Clause 2: The system of clause 1, wherein, when receiving the order message, the at least one processor is programmed or configured to: receive the order message from the user device of a consumer involved in the payment transaction.

Clause 3: The system of clauses 1 or 2, wherein, when receiving the order message, the at least one processor is programmed or configured to: receive the order message from the user device prior to determining that the user device is in proximity to the location of the merchant location.

Clause 4: The system of any of clauses 1-3, wherein the at least one processor is further programmed or configured to: transmit a control signal for operating the controlled delivery system to the user device; and cause the user device to transmit the control signal to the controlled delivery system via a short-range wireless communication connection to cause the controlled delivery system to release the item.

Clause 5: The system of any of clauses 1-4, wherein, when causing the controlled delivery system to release the item, the at least one processor is programmed or configured to: transmit a control signal to the controlled delivery system to cause the controlled delivery system to release the item.

Clause 6: The system of any of clauses 1-5, wherein the user device comprises a head unit of a vehicle.

Clause 7: The system of any of clauses 1-6, wherein, when determining that the user device is in proximity to the location of the merchant location, the at least one processor is further programmed or configured to: receive user identification data associated with a user identifier from the user device; receive, from the controlled delivery system, user verification data associated with verification of a user device, the user verification data comprising a user identifier transmitted to the controlled delivery system via a short-range wireless communication connection; compare the user identifier received from the user device and the user identifier received by the controlled delivery system; and determine that the user device is in proximity to the location of the merchant location based on comparing the user identifier received from the user device and the user identifier received by the controlled delivery system.

Clause 8: A computer-implemented method for providing an item from a controlled delivery system, the computer-implemented method comprising: receiving, with at least one processor, an order message from a user device; determining, with at least one processor, that a payment transaction associated with the order is processed; transmitting, with at least one processor, purchase item data to a controlled delivery system at a merchant location based on determining that the payment transaction associated with the order is processed; determining, with at least one processor, whether the user device is in proximity to a location of the merchant location; and causing, with at least one processor, the controlled delivery system to release the item based on determining that the user device is in proximity to the location of the merchant location.

Clause 9: The computer-implemented method of clause 8, further comprising: receiving the order message from the user device; and determining a location of the user device based on location data associated with the location of the user device; and wherein determining, with at least one processor, that the user device is in proximity to the location of the merchant location comprises: determining, with at least one processor, that the user device is in proximity to the location of the merchant location based on the location of the user device.

Clause 10: The computer-implemented method of clause 8 or 9, wherein receiving, with at least one processor, the order message comprises: receiving, with at least one processor, the order message from the user device when the user device is not in proximity to the location of the merchant location.

Clause 11: The computer-implemented method of any of clauses 8-10, further comprising: transmitting, with at least one processor, a control signal to the user device, wherein the control signal causes the controlled delivery system to operate; and causing, with at least one processor, the controlled delivery system to release the item based on receiving the control signal via a short range wireless communication connection.

Clause 12: The computer-implemented method of any of clauses 8-11, wherein determining, with at least one processor, whether the user device is in proximity to the location of the merchant location comprises: receiving location data associated with a location of the user device; comparing the location of the user device to the location of the merchant location; and determining that the user device is in proximity to the location of the merchant location based on the location of the user device.

Clause 13: The computer-implemented method of any of clauses 8-12, further comprising: authenticating, with at least one processor, the user device for access to the controlled delivery system based on determining that the user device is in proximity to the location of the merchant location.

Clause 14: The computer-implemented method of any of clauses 8-13, wherein authenticating, with at least one processor, the user device for access to the controlled delivery system comprises: transmitting, with at least one processor, authentication request data associated with an authentication request to the user device; receiving, with at least one processor, authentication response data associated with an authentication response from the user device; and determining, with at least one processor, that the authentication response is valid.

Clause 15: A computer program product for providing an item from a controlled delivery system, the computer program product comprising at least one non-transitory computer-readable medium comprising one or more instructions that, when executed by at least one processor, cause the at least one processor to: receive an order message, wherein the order message includes purchase item data associated with an item that is involved in an order; determine that a payment transaction for the order is processed; transmit the purchase item data to a controlled delivery system at a location of a merchant location based on determining that the payment transaction associated with the order is processed; determine that a user device is in proximity to the merchant location; and cause the controlled delivery system to release the item based on determining the user device is in proximity to the merchant location.

Clause 16: The computer program product of clause 15, wherein the one or more instructions that cause the at least one processor to receive the order message cause the at least one processor to: receive the order message from the user device.

Clause 17: The computer program product of clauses 15 or 16, wherein the one or more instructions further cause the at least one processor to: process the payment transaction based on receiving the order message.

Clause 18: The computer program product of any of clauses 15-17, wherein the one or more instructions further cause the at least one processor to: transmit, to the user device, a control signal to the user device, wherein the control signal causes the controlled delivery system to operate; cause the controlled delivery system to release the item based on receiving the control signal via a short-range wireless communication connection from the user device.

Clause 19: The computer program product of any of clauses 15-18, wherein the merchant location comprises the controlled delivery system, and wherein the one or more instructions that cause the at least one processor to determine that the user device is in proximity to the merchant location cause the at least one processor to: determine that the user device is in proximity to the controlled delivery system; and wherein the one or more instructions that cause the at least one processor to determine that the user device is in proximity to the controlled delivery system cause the at least one processor to: receive location data associated with a location of the user device from the user device; compare the location of the user device to a location of the controlled delivery system; and determine the user device is in proximity to the controlled delivery system.

Clause 20: The computer program product of any of clauses 15-19, wherein the one or more instructions further cause the at least one processor to: authenticate an identity of the user device for access to the controlled delivery system, wherein the one or more instructions that cause the at least one processor to authenticate the identity of the user device cause the at least one processor to: transmit authentication request data associated with an authentication request to the user device; receive authentication response data associated with an authentication response from the user device, wherein the authentication response data comprises identification data associated with the identity of the user device; and determine that the identifier of the user device is valid based on the identity of the user device.

These and other features and characteristics of the presently disclosed subject matter, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter. As used in the specification and the claims, the singular form of “a,” “an,” and “the” include plural referents unless the context clearly dictates otherwise.

### BRIEF DESCRIPTION OF THE DRAWINGS

Additional advantages and details of the disclosed subject matter are explained in greater detail below with reference to the exemplary embodiments or aspects that are illustrated in the accompanying figures, in which:

FIG. 1 is a diagram of a non-limiting embodiment or aspect of an environment in which methods, systems, and/or computer program products, described herein, may be implemented according to the principles of the presently disclosed subject matter;

FIG. 2 is a diagram of a non-limiting embodiment or aspect of components of one or more devices of FIG. 1;

FIG. 3 is a flowchart of a non-limiting embodiment or aspect of a process for providing an item from a controlled delivery system according to the principles of the presently disclosed subject matter; and

FIGS. 4A-4D are a diagram of an implementation of a non-limiting embodiment or aspect of a process disclosed herein.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively send information to the second unit. As another example, a first unit may be in communication with a second unit if at least one intermediary unit (e.g., a third unit located between the first unit and the second unit) processes information received from the first unit and sends the processed information to the second unit. In some non-limiting embodiments, a message may refer to a network packet (e.g., a data packet and/or the like) that includes data.

As used herein, the terms “issuer,” “issuer institution,” “issuer bank,” or “payment device issuer,” may refer to one or more entities that provide accounts to individuals (e.g., users, customers, and/or the like) for conducting payment transactions such as such as credit payment transactions and/or debit payment transactions. For example, an issuer institution may provide an account identifier, such as a primary account number (PAN), to a customer that uniquely identifies one or more accounts associated with that customer. In some non-limiting embodiments, an issuer may be associated with a bank identification number (BIN) that uniquely identifies the issuer institution. As used herein “issuer system” may refer to one or more computer systems operated by or on behalf of an issuer, such as a server executing one or more software applications. For example, an issuer system may include one or more authorization servers for authorizing a transaction.

As used herein, the term “account identifier” may include one or more types of identifiers associated with an account (e.g., a PAN associated with an account, a card number associated with an account, a payment card number associated with an account, a token associated with an account, and/or the like). In some non-limiting embodiments, an issuer may provide an account identifier (e.g., a PAN, a token, and/or the like) to a user (e.g., an account holder) that uniquely identifies one or more accounts associated with that user. The account identifier may be embodied on a payment device (e.g., a physical instrument used for conducting payment transactions, such as a payment card, a credit card, a debit card, a gift card, and/or the like) and/or may be electronic information communicated to the user that the user may use for electronic payment transactions. In some non-limiting embodiments, the account identifier may be an original account identifier, where the original account identifier was provided to a user at the creation of the account associated with the account identifier. In some non-limiting embodiments, the account identifier may be a supplemental account identifier, which may include an account identifier that is provided to a user after the original account identifier was provided to the user. For example, if the original account identifier is forgotten, stolen, and/or the like, a supplemental account identifier may be provided to the user. In some non-limiting embodiments, an account identifier may be directly or indirectly associated with an issuer institution such that an account identifier may be a token that maps to a PAN or other type of account identifier. Account identifiers may be alphanumeric, any combination of characters and/or symbols, and/or the like.

As used herein, the term “token” may refer to an identifier that is used as a substitute or replacement for another, prior, identifier. In some non-limiting embodiments, the identifier may be encrypted so that the prior identifier is undiscoverable. In some non-limiting embodiments, a token may include an account identifier that is used as a substitute or replacement for another account identifier, such as a PAN. Tokens may be associated with a PAN or other original account identifier in one or more data structures (e.g., one or more databases and/or the like) such that they may be used to conduct a payment transaction without directly using the original account identifier. In some non-limiting embodiments, an original account identifier, such as a PAN, may be associated with a plurality of tokens for different individuals or purposes. In some non-limiting embodiments, tokens may be associated with a PAN or other account identifiers in one or more data structures such that they can be used to conduct a transaction without directly using the PAN or the other account identifiers. In some examples, an account identifier, such as a PAN, may be associated with a plurality of tokens for different uses or different purposes.

As used herein, the term “merchant” may refer to one or more entities (e.g., operators of retail businesses) that provide goods, services, and/or access to goods and/or services, to a user (e.g., a customer, a consumer, and/or the like) based on a transaction such as a payment transaction. As used herein, the term “merchant system” may refer to one or more computer systems operated by or on behalf of a merchant, such as a server executing one or more software applications. As used herein, the term “product” may refer to one or more goods and/or services offered by a merchant.

As used herein, the term “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, radio frequency identification (RFID) receivers, and/or other contactless transceivers or receivers, contact-based receivers, payment terminals, and/or the like.

As used herein, the term “POS system” may refer to one or more client devices and/or peripheral devices used by a merchant to conduct a transaction. For example, a POS system may include one or more POS devices and/or other like devices that may be used to conduct a payment transaction. In some non-limiting embodiments, a POS system (e.g., a merchant POS system) may include one or more server computers programmed or configured to process online payment transactions through webpages, mobile applications, and/or the like.

As used herein, the term “transaction service provider” may refer to an entity that receives transaction authorization requests from merchants or other entities and provides guarantees of payment, in some cases through an agreement between the transaction service provider and an issuer institution. In some non-limiting embodiments, a transaction service provider may include a credit card company, a debit card company, a payment network such as Visa®, MasterCard®, AmericanExpress®, or any other entity that processes transaction. As used herein, the term “transaction service provider system” may refer to one or more computer systems operated by or on behalf of a transaction service provider, such as a transaction service provider system executing one or more software applications. A transaction service provider system may include one or more processors and, in some non-limiting embodiments, may be operated by or on behalf of a transaction service provider.

As used herein, the term “acquirer” may refer to an entity licensed by the transaction service provider and approved by the transaction service provider to originate transactions (e.g., payment transactions) involving a payment device associated with the transaction service provider. As used herein, the term “acquirer system” may also refer to one or more computer systems, computer devices, and/or the like operated by or on behalf of an acquirer. The transactions the acquirer may originate may include payment transactions (e.g., purchases, original credit transactions (OCTs), account funding transactions (AFTs), and/or the like). In some non-limiting embodiments, the acquirer may be authorized by the transaction service provider to assign merchant or service providers to originate transactions involving a payment device associated with the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by the acquirer's payment facilitators, and/or the like. In some non-limiting embodiments, an acquirer may be a financial institution, such as a bank.

As used herein, the terms “electronic wallet,” “electronic wallet mobile application,” and “digital wallet” may refer to one or more electronic devices including one or more software applications configured to facilitate and/or conduct transactions (e.g., payment transactions, electronic payment transactions, and/or the like). For example, an electronic wallet may include a user device (e.g., a mobile device, a smart watch, and/or the like) executing an application program and server-side software and/or databases for maintaining and providing data to be used during a payment transaction to the user device. As used herein, the term “electronic wallet provider” may include an entity that provides and/or maintains an electronic wallet and/or an electronic wallet mobile application for a user (e.g., a customer). Examples of an electronic wallet provider include, but are not limited to, Google Pay®, Android Pay®, Apple Pay®, and Samsung Pay®. In some non-limiting examples, a financial institution (e.g., an issuer institution) may be an electronic wallet provider. As used herein, the term “electronic wallet provider system” may refer to one or more computer systems, computer devices, servers, groups of servers, and/or the like operated by or on behalf of an electronic wallet provider.

As used herein, the term “payment device” may refer to a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, and/or the like. The payment device may include a volatile or a non-volatile memory to store information (e.g., an account identifier, a name of the account holder, and/or the like).

As used herein, the terms “client” and “client device” may refer to one or more computing devices, such as processors, storage devices, and/or similar computer components, that access a service made available by a server. In some non-limiting embodiments, a “client device” may refer to one or more devices that facilitate payment transactions, such as POS devices and/or POS systems used by a merchant. In some non-limiting embodiments, a client device may include an electronic device configured to communicate with one or more networks and/or facilitate payment transactions such as, but not limited to, one or more desktop computers, one or more portable computers (e.g., tablet computers), one or more mobile devices (e.g., cellular phones, smartphones, personal digital assistants (PDAs), wearable devices, such as watches glasses, lenses, and/or clothing, and/or the like), and/or the like. Moreover, a “client” may also refer to an entity, such as a merchant, that owns, utilizes, and/or operates a client device for facilitating payment transactions with a transaction service provider.

As used herein, the term “server” may refer to one or more computing devices, such as processors, storage devices, and/or similar computer components that communicate with client devices and/or other computing devices over a network, such as the Internet or private networks and, in some examples, facilitate communication among other servers and/or clients.

As used herein, the term “system” may refer to one or more computing devices or combinations of computing devices such as, but not limited to, processors, servers, client devices, software applications, and/or other like components. In addition, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

Systems, methods, and computer program products are disclosed herein for a controlled delivery system. In some non-limiting embodiments, these systems, methods, and computer program products may be configured to receive an order message (e.g., from a user device), the order message including purchase item data associated with an item that is involved in an order. A determination may be made that a payment transaction for the order is processed. Purchase item data may be transmitted (prior to or after receipt of an order message) to a controlled delivery system at a merchant location. In some non-limiting embodiments, the purchase item data may be transmitted based on the determination that the payment transaction for the order is processed. When it is determined that a user device is in proximity to the merchant location, a control signal may be transmitted to cause the controlled delivery system to release the item based on determining the user device is in proximity to the merchant location.

In this way, an individual may place an order to be securely picked up via a controlled delivery system and the order may be only available to be picked up solely by the individual that placed the order. This allows individuals to schedule the preparation and pickup of items at a merchant location prior to the completion of a payment transaction. Furthermore, a number of messages that are required to be transmitted and received for the order may be reduced. In addition, the condition of the subject of the order may be in a good condition (e.g., not deteriorated) since the order may be prepared within an amount of time of the individual placing the order. Embodiments of the present disclosure are also advantageous in that they may reduce and/or eliminate the need for a point-of-sale terminal. Additionally, no third-party delivery service needs to be relied upon (e.g., a parcel delivery service) to deliver the subject of the order.

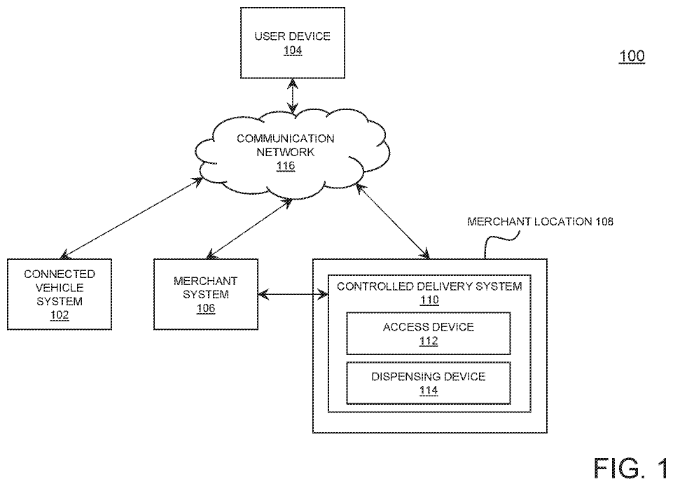

Referring now to FIG. 1, FIG. 1 is a diagram of an example environment 100 in which devices, systems, and/or methods, described herein, may be implemented. As shown in FIG. 1, environment 100 includes connected vehicle system 102, user device 104, merchant system 106, controlled delivery system 110, access device 112, dispensing device 114, and communication network 116. Connected vehicle system 102, user device 104, merchant system 106, controlled delivery system 110, access device 112, and dispensing device 114 may interconnect (e.g., establish a connection to communicate) via wired connections, wireless connections, or a combination of wired and wireless connections.

Connected vehicle system 102 may include one or more devices capable of being in communication with user device 104, merchant system 106, controlled delivery system 110, access device 112, and/or dispensing device 114 via communication network 116. For example, connected vehicle system 102 may include a device capable of communicating data to and/or from user device 104, merchant system 106, controlled delivery system 110, access device 112, and/or dispensing device 114 via communication network 116. In some non-limiting embodiments, connected vehicle system 102 may include a computing device, such as a server, a group of servers, and/or the like. In some non-limiting embodiments, connected vehicle system 102 may be associated with a merchant and/or a transaction service provider as described herein.

User device 104 may include one or more devices capable of being in communication with connected vehicle system 102, merchant system 106, controlled delivery system 110, access device 112, and/or dispensing device 114 via communication network 116. In some non-limiting embodiments, user device 104 may include a client device and/or the like. In some non-limiting embodiments, user device 104 may communicate with another computing device or system (e.g., controlled delivery system 110, access device 112, and/or dispensing device 114) via a short range wireless communication connection (e.g., an NFC communication connection, an RFID communication connection, a Bluetooth® communication connection, and/or the like). In some non-limiting embodiments, user device 104 may include a computing device that is integrated into a vehicle (e.g., a head unit of vehicle, a computing device mounted to a vehicle, and/or the like). In some non-limiting embodiments, a vehicle may include a car, a truck, a motorcycle, an all-terrain vehicle (ATV), and/or the like. In some non-limiting embodiments, user device 104 may be one or more devices configured to be in communication with one another (e.g., a smartphone may be configured to communicate with a head unit of a vehicle, and/or the like). In some non-limiting embodiments, user device 104 (e.g., one or more devices of user device 104) may include a global positioning system (GPS) sensor that may determine location data associated with a location (e.g., GPS location data associated with a GPS location) of user device 104.

Merchant system 106 may include one or more devices capable of being in communication with connected vehicle system 102, user device 104, controlled delivery system 110, access device 112, and/or dispensing device 114 via communication network 116. For example, merchant system 106 may include a device capable of communicating data to and/or from connected vehicle system 102, user device 104, controlled delivery system 110, access device 112, and/or dispensing device 114 via the communication network 116. In some non-limiting embodiments, merchant system 106 may include a computing device, such as a server, a group of servers and/or the like. In some non-limiting embodiments, merchant system 106 may be associated with a merchant and/or a transaction service provider as described herein.

Controlled delivery system 110 may include one or more devices capable of being in communication with connected vehicle system 102, user device 104, merchant system 106, access device 112, and/or dispensing device 114 via communication network 116. In some non-limiting embodiments, controlled delivery system 110 may include a computing device, such as a server, a group of servers and/or the like. In some non-limiting embodiments, controlled delivery system 110 may include a computing device capable of being in communication with another computing device (e.g., user device 104, access device 112, and/or dispensing device 114) via a short range wireless communication connection. In some non-limiting embodiments, connected vehicle system 102 may be associated with a merchant as described herein. In some non-limiting embodiments, controlled delivery system 110 may be located at a merchant location (e.g., positioned within merchant location 108, attached to merchant location, and/or the like) or within a geographic region associated with a merchant location (e.g., in proximity to merchant location 108 but not positioned within or attached to merchant location 108).

In some non-limiting embodiments, controlled delivery system 110 may include access device 112 and/or dispensing device 114. In some non-limiting embodiments, connected vehicle system 102 may include controlled delivery system 110 and any components thereof. In some non-limiting embodiments, an access device 112 and/or a dispensing device 114 may be separate from controlled delivery system 110. In some non-limiting embodiments, access device 112 may be located within a merchant location 108.

Access device 112 may include one or more devices capable of being in communication with connected vehicle system 102, user device 104, merchant system 106, controlled delivery system 110, and/or dispensing device 114 via communication network 116. In some non-limiting embodiments, access device 112 may include a computing device, such as a server, a group of servers and/or the like. In some non-limiting embodiments, access device 112 may include a computing device capable of being in communication with another computing device (e.g., user device 104, controlled delivery system 110, and/or dispensing device 114) via a short range wireless communication connection. In some non-limiting embodiments, access device 112 may be associated with a merchant as described herein. For example, access device 112 may be a physical apparatus that opens and closes based on receiving a control signal. Access device 112 may include a door secured by a mechanical latch, an actuator, and/or the like, a rolling conveyor belt cooperating with a door to secure an item, a robotic arm operating with a door to secure an item, and/or the like.

Dispensing device 114 may include one or more devices capable of being in communication with connected vehicle system 102, user device 104, merchant system 106, controlled delivery system 110, and/or access device 112 via communication network 116. In some non-limiting embodiments, dispensing device 114 may include a computing device, such as a server, a group of servers and/or the like. In some non-limiting embodiments, controlled delivery system 110 may include a computing device capable of being in communication with another computing device (e.g., user device 104, controlled delivery system 110, and/or access device 112) via a short range wireless communication connection. In some non-limiting embodiments, access device 112 may be associated with a merchant as described herein. In some non-limiting embodiments, dispensing device 114 may be associated with a merchant as described herein. In some non-limiting embodiments, dispensing device 114 may be located within a merchant location 108. For example, dispensing device 114 (e.g., a liquid dispenser, a solid dispenser, and/or the like) may control the dispensing of an item (e.g., one or more products) included in an order.

Communication network 116 may include one or more wired and/or wireless networks. For example, communication network 116 may include a cellular network (e.g., a long-term evolution (LTE) network, a third generation (3G) network, a fourth generation (4G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally or alternatively, a set of devices (e.g., one or more devices) of environment 100 may perform one or more functions described as being performed by another set of devices of environment 100.

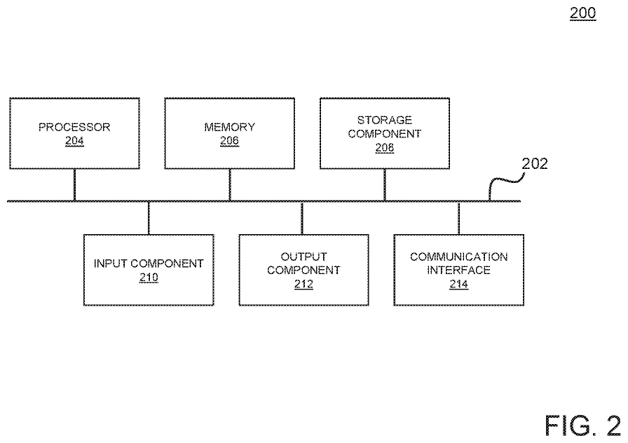

Referring now to FIG. 2, FIG. 2 is a diagram of example components of a device 200. Device 200 may correspond to connected vehicle system 102 (e.g., one or more devices of connected vehicle system 102), user device 104 (e.g., one or more devices of user device 104), merchant system 106 (e.g., one or more devices of merchant system 106), controlled delivery system 110 (e.g., one or more devices of controlled delivery system 110), access device 112 (e.g., one or more devices of access device 112), and/or dispensing device 114 (e.g., one or more devices of dispensing device 114). In some non-limiting embodiments, connected vehicle system 102, user device 104, merchant system 106, controlled delivery system 110, access device 112, and/or dispensing device 114 may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read only memory (ROM), and/or another type of dynamic or static storage memory (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally, or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 2 are provided as an example. In some non-limiting embodiments, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

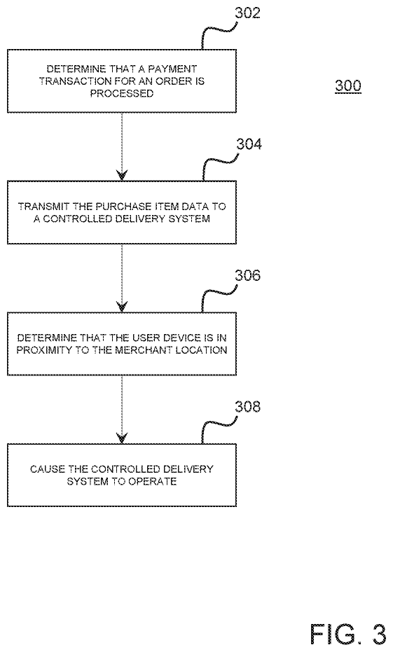

Referring now to FIG. 3, FIG. 3 is a flowchart of a non-limiting embodiment of a process 300 for providing an item from a controlled delivery system.

In some non-limiting embodiments, one or more of the steps of process 300 may be performed (e.g., completely, partially, and/or the like) by connected vehicle system 102 (e.g., one or more devices of connected vehicle system 102). In some non-limiting embodiments, one or more of the steps of process 300 may be performed (e.g., completely, partially, etc.) by another device or a group of devices separate from or including connected vehicle system 102 (e.g., one or more devices of connected vehicle system 102), user device 104, merchant system 106 (e.g., one or more devices of merchant system 106), controlled delivery system 110 (e.g., one or more devices of controlled delivery system 110 such as access device 112, and/or dispensing device 114).

As shown in FIG. 3, at step 302, process 300 includes determining that a payment transaction for an order is processed. For example, connected vehicle system 102 may determine that a payment transaction for an order is processed based on data received from user device 104, merchant system 106, a transaction service provider system, and/or the like. In some non-limiting embodiments, the payment transaction may involve a consumer associated with user device 104 and a merchant (e.g., a merchant associated with merchant system 106, a merchant associated with merchant location 108, a merchant associated with merchant system 106 and merchant location 108, and/or the like). In some non-limiting embodiments, connected vehicle system 102 may process the payment transaction for the order. For example, connected vehicle system 102 may process the payment transaction for the order based on receiving an order message associated with the order.

In some non-limiting embodiments, connected vehicle system 102 may receive an order message from user device 104. In some non-limiting embodiments, an order message may include purchase item data associated with an item (e.g., one or more products) that is involved in an order. In some non-limiting embodiments, the purchase item data may include data associated with the item involved in the order. For example, the purchase item data may include a list of one or more products that are included in the order, instructions for preparing a product that is included in the order (e.g., instructions for preparing a food item included in the order), and/or the like.

In some non-limiting embodiments, user device 104 may transmit an order message when user device 104 is not in proximity to merchant location 108 (e.g., when placing an order in advance of pickup of the order when user device 104 is not located at merchant location 108). In some non-limiting embodiments, an order message may be generated by user device 104 in real-time (e.g., based on input received at user device 104 in real-time, and/or the like) and/or may be pre-configured (e.g., may be based on input received during a prior order, based on historical data associated with a prior order and/or the like).

In some non-limiting embodiments, connected vehicle system 102 may receive an order message from user device 104 that is involved in a payment transaction with a merchant. In some non-limiting embodiments, user device 104 may transmit the order message to connected vehicle system 102 upon initiation and/or completion of an order during which an item is purchased via the payment transaction. In some non-limiting embodiments, user device 104 may transmit the order message to connected vehicle system 102 when user device 104 is not at merchant location 108 (e.g., when user device 104 is not within a predetermined distance of merchant location 108). In some non-limiting embodiments, user device 104 may transmit the order message to controlled delivery system 110 and controlled delivery system 110 may transmit the order message to merchant system 106 and/or connected vehicle system 102.

In some non-limiting embodiments, connected vehicle system 102 may determine whether a payment transaction for an order is processed. For example, connected vehicle system 102 may determine whether the payment transaction for the order is processed based on receiving a payment transaction confirmation message (e.g., an order message transmitted to connected vehicle system 102 by user device 104, merchant system 106, and/or controlled delivery system 110) associated with the order. In some non-limiting embodiments, connected vehicle system 102 may determine whether the payment transaction for the order is processed based on receiving data included in the payment transaction confirmation. For example, connected vehicle system 102 may determine that the payment transaction for the order is processed based on receiving an indication included in the payment transaction confirmation that the payment transaction was processed. In another example, connected vehicle system 102 may determine that the payment transaction for the order is not processed based on receiving an indication included in the payment transaction confirmation that the payment transaction was not processed.

In some non-limiting embodiments, connected vehicle system 102 may generate a payment transaction confirmation message based on receiving an order message. For example, connected vehicle system 102 may receive the order message from user device 104, merchant system 106, and/or controlled delivery system 110 and, upon receipt, may generate the payment transaction confirmation message based on receiving the order message. In some non-limiting embodiments, connected vehicle system 102 may transmit the payment transaction confirmation message to user device 104, merchant system 106, controlled delivery system 110, and/or a transaction service provider system, and connected vehicle system 102 may receive a response (e.g., a response message) to the payment transaction confirmation message that includes an indication of whether the payment transaction was or was not processed.

As shown in FIG. 3, at step 304, process 300 includes transmitting purchase item data to a controlled delivery system. For example, connected vehicle system 102 may transmit the purchase item data with an item that is involved in an order to controlled delivery system 110 based on determining that a payment transaction associated with an order is processed.

In some non-limiting embodiments, connected vehicle system 102 may transmit purchase item data associated with an item that is involved in an order. For example, connected vehicle system 102 may transmit purchase item data associated with an item that is involved in an order to controlled delivery system 110 and/or merchant system 106 (e.g., to cause controlled delivery system 110 to prepare the item corresponding to the order). In some non-limiting embodiments, connected vehicle system 102 may transmit the purchase item data to controlled delivery system 110. For example, connected vehicle system 102 may transmit purchase item data to controlled delivery system 110 at merchant location 108. In some non-limiting embodiments, connected vehicle system 102 may transmit the purchase item data to controlled delivery system 110 at merchant location 108 based on determining a location of merchant location 108. In some non-limiting embodiments, connected vehicle system 102 may transmit the purchase item data based on determining that a payment transaction for the order is processed. In some non-limiting embodiments, connected vehicle system 102 may determine a location of merchant location 108 based on an order message and transmit purchase item data associated with an item that is involved in an order to controlled delivery system 110 associated with the location of merchant location 108.

In some non-limiting embodiments, connected vehicle system 102 may transmit the purchase item data to controlled delivery system 110 based on location data associated with user device 104. For example, connected vehicle system 102 may receive location data associated with a location of user device 104 (e.g., transmitted by user device 104 once, periodically, continuously, and/or the like). Connected vehicle system 102 may determine, based on the location data, the location of user device 104 and transmit purchase item data to controlled delivery system 110 when user device 104 is in proximity to controlled delivery system 110. In some non-limiting embodiments, connected vehicle system 102 may receive location data associated with a location of user device 104 (e.g., transmitted by user device 104 once, periodically, continuously, and/or the like).

In some non-limiting embodiments, controlled delivery system 110 may prepare an item involved in an order based on receiving the purchase item data. For example, controlled delivery system 110 may prepare the item involved in the order based on the purchase item data after receiving the purchase item data.

As shown in FIG. 3, at step 306, process 300 includes determining that user device 104 is in proximity to merchant location 108. For example, connected vehicle system 102 may determine that user device 104 is in proximity to merchant location 108 (e.g., a location of merchant location 108) based on the distance of user device 104 from merchant location 108.

In some non-limiting embodiments, connected vehicle system 102 may determine a distance of user device 104 from merchant location 108. In some non-limiting embodiments, connected vehicle system 102 may determine the distance of user device 104 from merchant location 108 based on a location of user device 104. For example, connected vehicle system 102 may compare a location of user device 104 to a location of merchant location 108 and determine the distance of user device 104 from merchant location 108. In some non-limiting embodiments, connected vehicle system 102 may compare a location of user device 104 to a location of merchant location 108 and determine the distance of user device 104 from merchant location 108 based on the difference between the location of user device 104 and the location of merchant location 108.

In some non-limiting embodiments, user device 104 may transmit location data associated with a location of user device 104. For example, user device 104 may transmit location data associated with a location of user device 104 to connected vehicle system 102 once, periodically (e.g., during predetermined periodic intervals), continuously, and/or the like. In some non-limiting embodiments, connected vehicle system 102 may determine the distance of user device 104 from merchant location 108 based on receiving location data associated with the location of user device 104. For example, connected vehicle system 102 may periodically and/or continuously determine the distance of user device 104 from merchant location 108 based on receiving the location data.

In some non-limiting embodiments, connected vehicle system 102 may determine whether user device 104 is in proximity to merchant location 108 based on a location of user device 104. For example, connected vehicle system 102 may receive location data associated with a location of user device 104 (e.g., from user device 104). Connected vehicle system 102 may determine a distance of user device 104 from merchant location 108 by comparing the location of user device 104 to a location of merchant location 108. Connected vehicle system 102 may determine that user device 104 is in proximity to the location of merchant location 108 based on comparing the location of user device 104 to the location of merchant location 108.

In some non-limiting embodiments, connected vehicle system 102 may determine whether a location of user device 104 is in proximity to merchant location 108 based on a threshold of distance. For example, connected vehicle system 102 may compare a distance of user device 104 from merchant location 108 to a threshold of distance (e.g., a predetermined amount of distance). If connected vehicle system 102 determines that the distance of user device 104 from merchant location 108 (e.g., a difference between a location of user device 104 and a location of merchant location 108) satisfies the threshold of distance, connected vehicle system 102 may determine that user device 104 is in proximity to merchant location 108 (e.g., within a predetermined distance of merchant location 108). If connected vehicle system 102 determines that the distance of user device 104 from merchant location 108 does not satisfy the threshold of distance, connected vehicle system 102 may determine that user device 104 is not in proximity to merchant location 108.

In some non-limiting embodiments, connected vehicle system 102 may transmit purchase item data associated with an item that is involved in an order and/or an order message to controlled delivery system 110 when user device 104 is in proximity to (e.g., determined to be in proximity to) merchant location 108. For example, connected vehicle system 102 may transmit the purchase item data associated with the item that is involved in the order and/or the order message to controlled delivery system 110 based on determining that user device 104 is within a threshold of distance of merchant location 108. In some non-limiting embodiments, connected vehicle system 102 may receive an order message from user device 104 prior to determining whether user device 104 is in proximity to merchant location 108 (e.g., in proximity to a location of merchant location 108). Additionally or alternatively, connected vehicle system 102 may receive the order message from user device 104 when user device 104 is not in proximity to merchant location 108.

In some non-limiting embodiments, connected vehicle system 102 may determine that user device 104 is in proximity to merchant location 108 based on a user identifier associated with user device 104. For example, connected vehicle system 102 may receive user identification data associated with a first user identifier of user device 104 from user device 104. Connected vehicle system 102 may receive user identification data associated with a second user identifier of user device 104 from controlled delivery system 110. Controlled delivery system 110 may have received the second user identifier of user device 104 from user device 104 via a short-range wireless communication connection. Connected vehicle system 102 may compare the first user identifier received from user device 104 to the second user identifier received from controlled delivery system 110. Connected vehicle system 102 may determine that user device 104 is in proximity to merchant location 108 (e.g., controlled delivery system 110 of merchant location 108) based on determining that the first user identifier corresponds to (e.g., matches) the second user identifier. Alternatively, connected vehicle system 102 may determine that user device 104 is not in proximity to merchant location 108 (e.g., controlled delivery system 110 of merchant location 108) based on determining that the first user identifier does not correspond to the second user identifier.

In some non-limiting embodiments, controlled delivery system 110 may prepare an item involved in an order based on connected vehicle system 102 determining that user device 104 is in proximity to merchant location 108. For example, connected vehicle system 102 may transmit a signal to controlled delivery system 110 based on connected vehicle system 102 determining that user device 104 is in proximity to merchant location 108 and controlled delivery system 110 may prepare an item involved in an order based on purchase item data associated with the item. In some non-limiting embodiments, controlled delivery system 110 may forego preparing an item involved in an order unless connected vehicle system 102 determines that user device 104 is in proximity to merchant location 108. For example, controlled delivery system 110 may forego preparing the item involved in the order until connected vehicle system 102 determines that user device 104 is in proximity to merchant location 108. In such an example, controlled delivery system 110 may begin to prepare the item based on connected vehicle system 102 determining that user device 104 is in proximity to merchant location 108.

As shown in FIG. 3, at step 308, process 300 includes causing the controlled delivery system to operate. For example, connected vehicle system 102 may cause controlled delivery system 110 to operate based on determining user device 104 is in proximity to merchant location 108 and/or controlled delivery system 110. For example, connected vehicle system 102 may cause controlled delivery system 110 to operate based on determining user device 104 is in proximity to controlled delivery system 110 (e.g., that user device 104 is within a predetermined distance of controlled delivery system 110). In some non-limiting embodiments, connected vehicle system 102 may transmit a control signal to controlled delivery system 110 to cause controlled delivery system 110 to release an item involved in an order. For example, connected vehicle system 102 may transmit the control signal to controlled delivery system 110 to cause access device 112 to operate (e.g., to open a door that restricts access to the item, to open a window that restricts access to the item, to unlock a gate that restricts access to the item, and/or the like). Additionally or alternatively, for example, connected vehicle system 102 may transmit the control signal to controlled delivery system 110 to cause dispensing device 114 to operate (e.g., to prepare the item, to provide the item, and/or the like).

In some non-limiting embodiments, connected vehicle system 102 may transmit a control signal associated with releasing an item involved in an order. For example, connected vehicle system 102 may transmit the control signal to cause controlled delivery system 110 to release an item involved in an order to user device 104. In some non-limiting embodiments, connected vehicle system 102 may transmit a control signal for releasing an item involved in an order to controlled delivery system 110. For example, connected vehicle system 102 may transmit the control signal to controlled delivery system 110 to cause controlled delivery system 110 to release the item involved in the order. In another example, connected vehicle system 102 may transmit the control signal to user device 104 and connected vehicle system 102 may cause user device 104 to transmit the control signal to the controlled delivery system 110 (e.g., via a short-range wireless communication connection). In some non-limiting embodiments, connected vehicle system 102 may transmit the control signal based on determining user device 104 is in proximity to controlled delivery system 110.

In some non-limiting embodiments, connected vehicle system 102 may authenticate user device 104 so that access to controlled delivery system 110 is provided. For example, connected vehicle system 102 may authenticate an identity of user device 104 (e.g., an identity of a consumer associated with user device 104) based on determining that user device 104 is in proximity to the location of the merchant location 108. In some non-limiting embodiments, connected vehicle system 102 may transmit authentication request data associated with an authentication request to user device 104 and may receive authentication response data associated with an authentication response from user device 104. The authentication response data may include identification data associated with an identifier of user device 104 (e.g., identification data associated with a device identifier of user device 104, identification data associated with an identity of a consumer associated with user device 104, and/or the like). Connected vehicle system 102 may determine that the authentication response is valid based on the authentication response data. For example, connected vehicle system 102 may compare the identifier of user device 104 to a plurality of identifiers that are stored in a data structure associated with connected vehicle system 102. If connected vehicle system 102 determines that the identifier of user device 104 corresponds to an identifier that is stored in the data structure (e.g., that the identifier of user device 104 is valid), connected vehicle system 102 may authenticate user device 104. If connected vehicle system 102 determines that the identifier of user device 104 does not correspond to an identifier that is stored in the data structure (e.g., that the identifier of user device 104 is not valid), connected vehicle system 102 may forego authenticating user device 104.

In some non-limiting embodiments, controlled delivery system 110 may authenticate a vehicle associated with user device 104 so that access to controlled delivery system 110 is provided. For example, controlled delivery system 110 may authenticate the vehicle associated with user device 104 by scanning a license plate of the vehicle with an image capture device (e.g., a camera) and comparing an image of the license plate of the vehicle to a plurality of images of license plates stored in a data structure. If controlled delivery system 110 determines that the image of the license plate of the vehicle corresponds to an image of a license plate that is stored in the data structure (e.g., that the image of the license plate of the vehicle is valid), controlled delivery system 110 may authenticate the vehicle associated with user device 104. If controlled delivery system 110 determines that the identifier of user device 104 does not correspond to an identifier that is stored in the data structure (e.g., that the image of the license plate of the vehicle is not valid), connected vehicle system 102 may forego authenticating the vehicle associated with user device 104. In some non-limiting embodiments, connected vehicle system 102 may carry one or more of the functions described above regarding authenticating the vehicle associated with user device 104.

In some non-limiting embodiments, connected vehicle system 102 and/or controlled delivery system 110 may authenticate user device 104 based on a one-time password and/or secured release token (e.g., a limited use secured release token). For example, connected vehicle system 102 and/or controlled delivery system 110 may receive the one-time password and/or the secured release token from user device 104. Connected vehicle system 102 and/or controlled delivery system 110 may compare the one-time password and/or the secured release token to security data stored in a data structure (e.g., data associated with a one-time password and/or a secured release token stored in a data structure). If connected vehicle system 102 and/or controlled delivery system 110 determines that the one-time password and/or the secured release token corresponds to the security data stored in the data structure (e.g., that the one-time password and/or the secured release token is valid), controlled delivery system 110 may authenticate user device 104. If controlled delivery system 110 determines that the identifier of user device 104 does not correspond to an identifier that is stored in the data structure (e.g., that the one-time password and/or the secured release token is not valid), connected vehicle system 102 may forego authenticating user device 104.

In some non-limiting embodiments, controlled delivery system 110 may release an item involved in an order when the one-time password and/or the secured release token are received by controlled delivery system 110. In some non-limiting embodiments, connected vehicle system 102 may transmit the one-time password and/or the secured release token to user device 104. In some non-limiting embodiments, user device 104 may transmit the one-time password and/or the secured release token to controlled delivery system 110 (e.g., via a short range wireless communication connection) when user device 104 is in proximity to controlled delivery system 110 and controlled delivery system 110 may release an item involved in an order based on receiving the one-time password and/or the secured release token.

In some non-limiting embodiments, connected vehicle system 102 may generate the one-time password and/or a secured release token. For example, connected vehicle system 102 may generate the one-time password and/or the secured release token based on an order message (e.g., an order message received from user device 104, merchant system 106, and/or controlled delivery system 110). In some non-limiting embodiments, user device 104 may transmit a one-time password and/or a secured release token to another user device (e.g., user device 104-1, another user device 104). For example, user device 104 may transmit the one-time password and/or the secured release token to the user device 104-1 based on receiving the one-time password and/or the secured release token from connected vehicle system 102. User device 104-1 may be authenticated by connected vehicle system 102 and/or controlled delivery system 110 based on the one-time password and/or the secured release token received from user device 104.

In some non-limiting embodiments, connected vehicle system 102 may transmit the control signal to controlled delivery system 110 based on authenticating user device 104. For example, connected vehicle system 102 may transmit the control signal to controlled delivery system 110 based on connected vehicle system 102 and/or controlled delivery system 110 authenticating user device 104 using a one-time password and/or a secured release token (e.g., a one-time password and/or a secured release token associated with user device 104).

In some non-limiting embodiments, to cause controlled delivery system 110 to release an item involved in an order, user device 104 may transmit a signal (e.g., an initiation signal) to initiate authentication of user device 104. Controlled delivery system 110 may then establish a short range wireless communication connection with user device 104 and transmit authentication request data associated with an authentication request to user device 104. User device 104 may transmit authentication response data associated with an authentication response to controlled delivery system 110 via the short range wireless communication connection. For example, user device 104 may transmit authentication response data including a secured release token to controlled delivery system 110 via the short range wireless communication connection, thereby authenticating user device 104 as the appropriate device to release the item involved in the transaction to. Additionally, or alternatively, user device 104 may transmit the secured release token via communication network 116 to connected vehicle system 102, merchant system 106, and/or controlled delivery system 110. In some non-limiting embodiments, connected vehicle system 102 and/or merchant system 106 may forward the secured release token to controlled delivery system 110, to cause controlled delivery system 110 to determine the secured release token is valid and release the item involved in the order. In some non-limiting embodiments, user device 104 may transmit the secured release token to another computing device (e.g., a different mobile device, and/or the like), which may transmit the secured release token to cause controlled delivery system 110 to release the item involved in the order.

In some non-limiting embodiments, connected vehicle system 102 may receive a plurality of order messages for a plurality of orders to a single merchant location (e.g., merchant location 108) and the merchant location may include a plurality of controlled delivery systems 110. In one example, connected vehicle system 102 may receive, in a queue, a plurality of order messages for a plurality of orders from a plurality of user devices 104 to merchant location 108. In some non-limiting embodiments, controlled delivery system 110 may transmit a control signal based on the plurality of order messages in the queue. For example, connected vehicle system 102 may transmit the control signal to each of the plurality of controlled delivery systems 110 based on each of the plurality of order messages in the queue. In some non-limiting embodiments, connected vehicle system 102 may transmit a first control signal for a first order message to a first controlled delivery system 110 of the plurality of controlled delivery systems 110 based on determining that user device 104 (e.g., that transmitted the first order message) is in proximity to the first controlled delivery system 110.

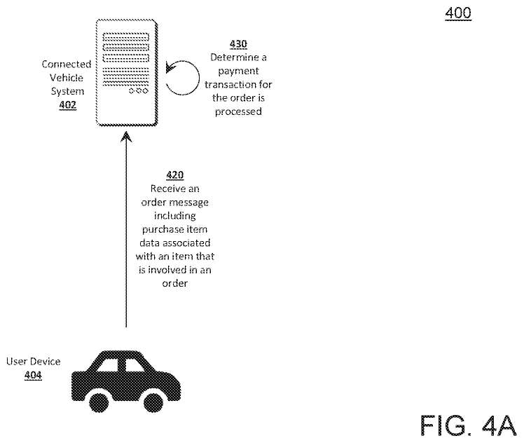

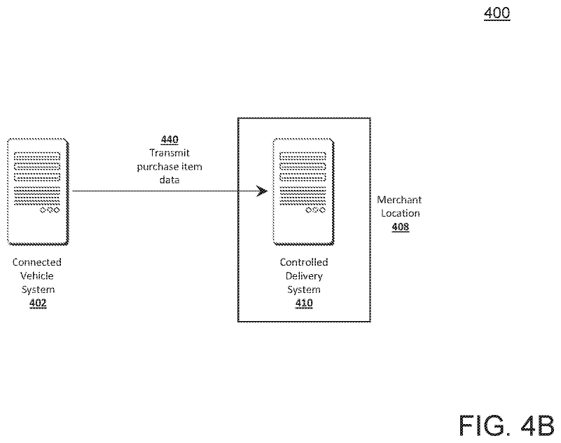

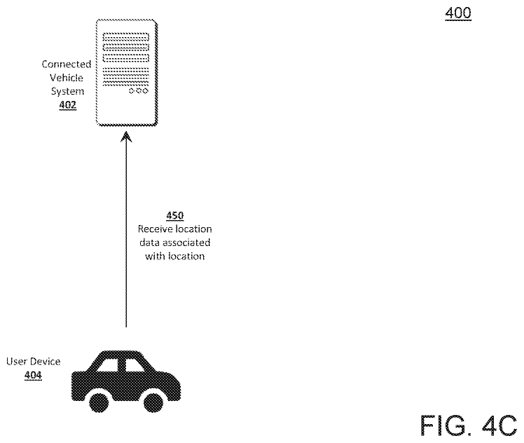

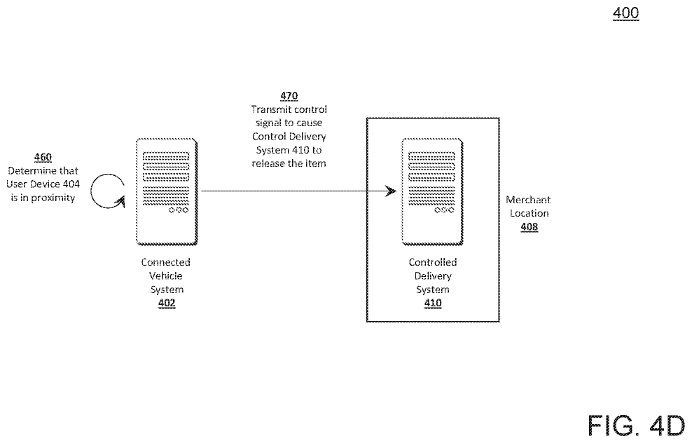

Referring now to FIGS. 4A-4D, FIGS. 4A-4D are a sequence diagram of a non-limiting embodiment of a process 400 for providing an item from a controlled delivery system. As shown, one or more of the steps of process 400 are performed (e.g., completely, partially, and/or the like) by connected vehicle system 402, user device 404, and/or controlled delivery system 410.

As shown by reference number 420 in FIG. 4A, connected vehicle system 402 may receive an order message including purchase item data associated with an item involved in an order. In some non-limiting embodiments, connected vehicle system 402 may receive an order message from a user device 404. For example, user device 404 may transmit an order message (e.g., an order message generated by user device 404, a merchant system (e.g., merchant system 106), and/or the like) including purchase item data associated with an item that is involved in an order (e.g., information about goods and/or services purchased from a merchant, a transaction identifier associated with a transaction, and/or the like).

As shown by reference number 430 in FIG. 4A, connected vehicle system 402 may determine a payment transaction for an order is processed. In some non-limiting embodiments, connected vehicle system 402 may determine a payment transaction for an order is processed based on purchase item data associated with an item involved in an order. For example, connected vehicle system 402 may determine a payment transaction for an order is processed based on receiving an order message from a user device 404.

As shown by reference number 440 in FIG. 4B, connected vehicle system 402 may transmit purchase item data. In some non-limiting embodiments, connected vehicle system 402 may transmit purchase item data associated with an item that is involved in an order to controlled delivery system 410. For example, connected vehicle system 402 may transmit purchase item data associated with an item to controlled delivery system 410, the purchase item data involved in an order that was received from a user device 404. In some non-limiting embodiments, controlled delivery system 410 may be located within merchant location 408. Purchase item data associated with an item that is involved in an order may include an item identifier associated with the item purchased, a unique order identifier associated with the order, an estimated pick-up time (e.g., a point in time by which the order is expected to be retrieved, a period in time during which the order is expected to be retrieved, and/or the like), a user identifier associated with a user device 404 (e.g., a user device 404 identified in the order message received from the user device 404), and/or the like).

In some non-limiting embodiments, connected vehicle system 402 may generate a token (e.g., a secured release token, a limited use secured release token, and/or the like). For example, connected vehicle system 402 may generate the token that, when received by controlled delivery system 410, causes controlled delivery system 410 to release an item that is involved in an order. In some non-limiting embodiments, connected vehicle system 402 may transmit the token with the purchase item data (e.g., by updating the purchase item data to include the token). In some non-limiting embodiments, connected vehicle system 402 may transmit the token to a user device 404.

As shown by reference number 450 in FIG. 4C, connected vehicle system 402 may receive location data associated with a location of the user device 404. In some non-limiting embodiments, connected vehicle system 402 may receive location data associated with a location of the user device 404 (e.g., coordinates derived from a global positioning system (GPS) signal received by the user device 404, coordinates and/or a geographic region determined based on wireless communication signal strength from one or more wireless towers, and/or the like).

As shown by reference number 460 in FIG. 4D, connected vehicle system 402 may determine user device 404 is in proximity to merchant location 408. In some non-limiting embodiments, connected vehicle system 402 may determine user device 404 is in proximity to merchant location 408 based on location data associated with merchant location 408 and location data associated with the location of user device 404. For example, connected vehicle system 402 may determine user device 404 is in proximity to merchant location 408 based on determining a distance of the location of user device 404 is within a predetermined distance of one or more points corresponding to merchant location 408.

In some non-limiting embodiments, connected vehicle system 402 may determine user device 404 is in proximity to merchant location 408 based on receiving location data associated with the location of user device 404 from controlled delivery system 410. For example, user device 404 may transmit a user identifier associated with user device 404 to controlled delivery system 410 via a short range wireless communication connection. Controlled delivery system 410 may transmit the user identifier received from user device 404 to connected vehicle system 402 (e.g., directly or via merchant system 106). Upon receipt of the user identifier from controlled delivery system 410, connected vehicle system 402 may determine user device 404 is in proximity to (e.g., within a predetermined distance of) controlled delivery system 410.

As shown by reference number 470 in FIG. 4D, connected vehicle system 402 may transmit a control signal to cause controlled delivery system 410 to release the item involved in the order. For example, connected vehicle system 402 may transmit a control signal to controlled delivery system 410 to cause controlled delivery system 410 to release the item involved in the order. In some non-limiting embodiments, upon receipt of the control signal, controlled delivery system 410 may transmit a control signal to access device 112 (e.g., a motor mechanically coupled to a door, and/or the like) to cause access device 112 to operate (e.g., transition from a locked configuration to an open configuration) and release the item involved in the order. In some non-limiting embodiments, controlled delivery system 410 may transmit a control signal (e.g., before or after transmitting a control signal to access device 112 to release the item involved in the order) to cause dispensing device 114 to dispense the item involved in the order.

Although the present disclosure has been described in detail for the purpose of illustration based on what is currently considered to be the most practical and preferred embodiments, it is to be understood that such detail is solely for that purpose and that the present disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A system for providing an item from a controlled delivery system, the system comprising:
at least one processor programmed or configured to:
receive an order message, wherein the order message comprises purchase item data associated with an item that is involved in an order;
determine that a payment transaction for the order is processed;
transmit the purchase item data to a controlled delivery system at a merchant location based on determining that the payment transaction associated with the order is processed;
determine that a user device is in proximity to the location of the merchant location; and
cause the controlled delivery system to release the item based on determining that the user device is in proximity to the location of the merchant location.

2. The system according to claim 1, wherein, when receiving the order message, the at least one processor is programmed or configured to:
receive the order message from the user device of a consumer involved in the payment transaction.

3. The system according to claim 2, wherein, when receiving the order message, the at least one processor is programmed or configured to:
receive the order message from the user device prior to determining that the user device is in proximity to the location of the merchant location.

4. The system according to claim 1, wherein the at least one processor is further programmed or configured to:
transmit a control signal for operating the controlled delivery system to the user device; and
cause the user device to transmit the control signal to the controlled delivery system via a short-range wireless communication connection to cause the controlled delivery system to release the item.

5. The system according to claim 1, wherein, when causing the controlled delivery system to release the item, the at least one processor is programmed or configured to:
transmit a control signal to the controlled delivery system to cause the controlled delivery system to release the item.

6. The system according to claim 1, wherein the user device comprises a head unit of a vehicle.

7. The system according to claim 1, wherein, when determining that the user device is in proximity to the location of the merchant location, the at least one processor is further programmed or configured to:
receive user identification data associated with a user identifier from the user device;
receive, from the controlled delivery system, user verification data associated with verification of a user device, the user verification data comprising a user identifier transmitted to the controlled delivery system via a short-range wireless communication connection;
compare the user identifier received from the user device and the user identifier received by the controlled delivery system; and
determine that the user device is in proximity to the location of the merchant location based on comparing the user identifier received from the user device and the user identifier received by the controlled delivery system.

8. A computer-implemented method for providing an item from a controlled delivery system, the computer-implemented method comprising:
receiving, with at least one processor, an order message from a user device;
determining, with at least one processor, that a payment transaction associated with the order is processed;
transmitting, with at least one processor, purchase item data to a controlled delivery system at a merchant location based on determining that the payment transaction associated with the order is processed;
determining, with at least one processor, whether the user device is in proximity to a location of the merchant location; and
causing, with at least one processor, the controlled delivery system to release the item based on determining that the user device is in proximity to the location of the merchant location.

9. The computer-implemented method according to claim 8, further comprising:
receiving the order message from the user device; and
determining a location of the user device based on location data associated with the location of the user device; and
wherein determining, with at least one processor, that the user device is in proximity to the location of the merchant location comprises:
determining, with at least one processor, that the user device is in proximity to the location of the merchant location based on the location of the user device.

10. The computer-implemented method according to claim 8, wherein receiving, with at least one processor, the order message comprises:
receiving, with at least one processor, the order message from the user device when the user device is not in proximity to the location of the merchant location.

11. The computer-implemented method according to claim 8, further comprising:
transmitting, with at least one processor, a control signal to the user device, wherein the control signal causes the controlled delivery system to operate; and
causing, with at least one processor, the controlled delivery system to release the item based on receiving the control signal via a short range wireless communication connection.

12. The computer-implemented method according to claim 8, wherein determining, with at least one processor, whether the user device is in proximity to the location of the merchant location comprises:
receiving location data associated with a location of the user device;
comparing the location of the user device to the location of the merchant location; and
determining that the user device is in proximity to the location of the merchant location based on the location of the user device.

13. The computer-implemented method according to claim 8, further comprising:
authenticating, with at least one processor, the user device for access to the controlled delivery system based on determining that the user device is in proximity to the location of the merchant location.

14. The computer-implemented method according to claim 13, wherein authenticating, with at least one processor, the user device for access to the controlled delivery system comprises:
transmitting, with at least one processor, authentication request data associated with an authentication request to the user device;
receiving, with at least one processor, authentication response data associated with an authentication response from the user device; and
determining, with at least one processor, that the authentication response is valid.

15. A computer program product for providing an item from a controlled delivery system, the computer program product comprising at least one non-transitory computer-readable medium comprising one or more instructions that, when executed by at least one processor, cause the at least one processor to:
receive an order message, wherein the order message includes purchase item data associated with an item that is involved in an order;
determine that a payment transaction for the order is processed;
transmit the purchase item data to a controlled delivery system at a location of a merchant location based on determining that the payment transaction associated with the order is processed;
determine that a user device is in proximity to the merchant location; and
cause the controlled delivery system to release the item based on determining the user device is in proximity to the merchant location.

16. The computer program product according to claim 15, wherein the one or more instructions that cause the at least one processor to receive the order message cause the at least one processor to:
receive the order message from the user device.

17. The computer program product according to claim 16, wherein the one or more instructions further cause the at least one processor to:
process the payment transaction based on receiving the order message.

18. The computer program product according to claim 15, wherein the one or more instructions further cause the at least one processor to:
transmit, to the user device, a control signal to the user device, wherein the control signal causes the controlled delivery system to operate;
cause the controlled delivery system to release the item based on receiving the control signal via a short-range wireless communication connection from the user device.

19. The computer program product according to claim 15, wherein the merchant location comprises the controlled delivery system, and wherein the one or more instructions that cause the at least one processor to determine that the user device is in proximity to the merchant location cause the at least one processor to:
determine that the user device is in proximity to the controlled delivery system; and
wherein the one or more instructions that cause the at least one processor to determine that the user device is in proximity to the controlled delivery system cause the at least one processor to:
receive location data associated with a location of the user device from the user device;
compare the location of the user device to a location of the controlled delivery system; and
determine the user device is in proximity to the controlled delivery system.

20. The computer program product according to claim 15, wherein the one or more instructions further cause the at least one processor to:
authenticate an identity of the user device for access to the controlled delivery system, wherein the one or more instructions that cause the at least one processor to authenticate the identity of the user device cause the at least one processor to:
transmit authentication request data associated with an authentication request to the user device;
receive authentication response data associated with an authentication response from the user device, wherein the authentication response data comprises identification data associated with the identity of the user device; and
determine that the identifier of the user device is valid based on the identity of the user device.
